(19) United States
(12) Patent Application Publication
(10) Pub. No.: US 2004/0126299 A1
(43) Pub. Date: Jul. 1, 2004

(54) Method for performing thermal reactions between reactants and a furnace for same

(76) Inventors: Dag Ovrebø, Porsgrunn (NO); William George Clark, Porsgrunn (NO)

Correspondence Address: WENDEROTH, LIND & PONACK, L.L.P., 2033 K STREET N. W., SUITE 800, WASHINGTON, DC, 20006-1021, US

(21) Appl. No.: 10/468,866

(22) PCT Filed: Feb. 6, 2002
(86) PCT No.: PCT/NO02/00052

(30) Foreign Application Priority Data
Feb. 23, 2001 (NO) 20010929

(51) Int. Cl. C01B 35/04; C01B 31/34

(52) U.S. Cl. 423/297; 423/440

(57) ABSTRACT

The present invention relates to thermal reactions performed at rapid transient temperatures, and a furnace (1) able to perform such reactions. The method and the furnace may suitably be applied to perform reactions between reactants where significant losses normally occur at certain transient temperatures or temperature ranges. One practical application of the present invention relates to a carbothermic method for producing Refractory Hard Metal powders, such as borides, nitrides and carbides, and a furnace designed for the performance of the method. In accordance with this method Refractory Hard Metal powders, such as boride powders can be produced with reduced loss of reactants such as C and B₂O₃. This can be achieved by rapid heating of the mixture containing the reactants in a critical temperature range. For the performance of this particular embodiment a two-step furnace has been applied, where the temperature in each individual temperature zone (37, 38) Is respectively below and above critical temperatures of the reaction. In accordance with one embodiment of the present invention high purified boride, carbide and nitride powders with a fine grain size can be produced in a simple and cost effective manner.

The present invention relates to thermal reactions performed at rapid transient temperatures, and a furnace able to perform such reactions. The method and furnace may suitably be applied to perform reactions between reactants where significant losses normally occur at certain transient temperatures or temperature ranges.

One practical application of the present invention relates to a carbothermic method for producing Refractory Hard Metal (RHM) powders, such as nitrides, carbides as well as borides, and a furnace designed for the performance of the method.

U.S. Pat. No. 5,338,523 relates to a method of making boride powders based upon mixing transition metal oxide with carbon and boron oxide. The mixture is heated in a reaction chamber under a non-reactive gas pressure until the reactants reach a temperature of between 1200° C. and 2000° C. wherein the pressure is maintained at a level sufficient to prevent the substantial loss of oxide or carbon from the reactants. Subsequently the temperature of the reactants is maintained between 1200° C. and 2000° C. to force the reactants to react producing borides and carbon monoxide as a byproduct and simultaneously there is applied a subatmospheric pressure to the reactants which is in the range from about 5 millitorrs to about 3000 millitorrs which pressure should be sufficient to remove carbon monoxide from the reaction chamber whereby the removal of the carbon monoxide drives the reaction to substantial completion. The reaction may take place in a rotary graphite container furnace having a variable speed-drive mechanism. The furnace is of a graphite resistance type where the heating rate applied is 50° C./min.

According to said reference the reaction takes place at a pressure that may be substantially different than that of the atmospheric pressure. This is likely because the reaction between C and B₂O₃ may be retarded by increasing the CO pressure. The furnace used in the process then have to be designed to withstand a reaction performed at pressures quite different to that of the atmospheric pressure, which followingly is more complicated and costly than furnace designed for performing a similar reaction at atmospheric pressures. Further, in said method the pressure is maintained when reaching the reaction temperature to prevent loss of oxide or carbon.

In accordance with one embodiment of the present invention Refractory Hard Metal powders may be produced in a less complicated and followingly a more cost effective manner. Further, the produced powder has approved to sustain a very high grade purity, where there is obtained a fine grain size of the powder. The invention further involves a novel furnace designed for performing the method, where it is possible to minimize the retention time at unwanted temperatures or temperature ranges.

The invention shall by means of example and figures be further described in the following where,

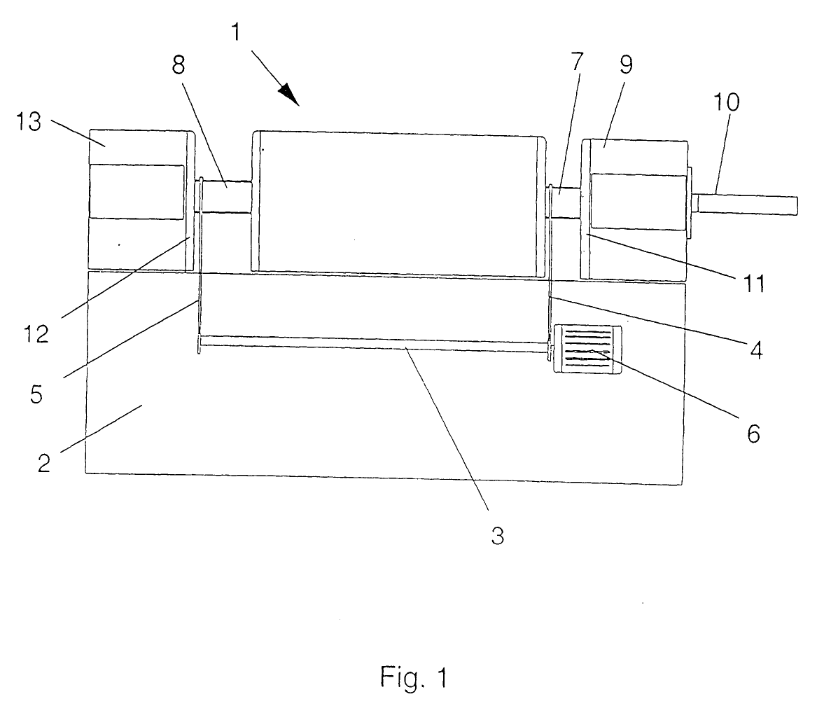

FIG. 1 is a sketch that discloses the main external parts a furnace in accordance with one embodiment of the present invention,

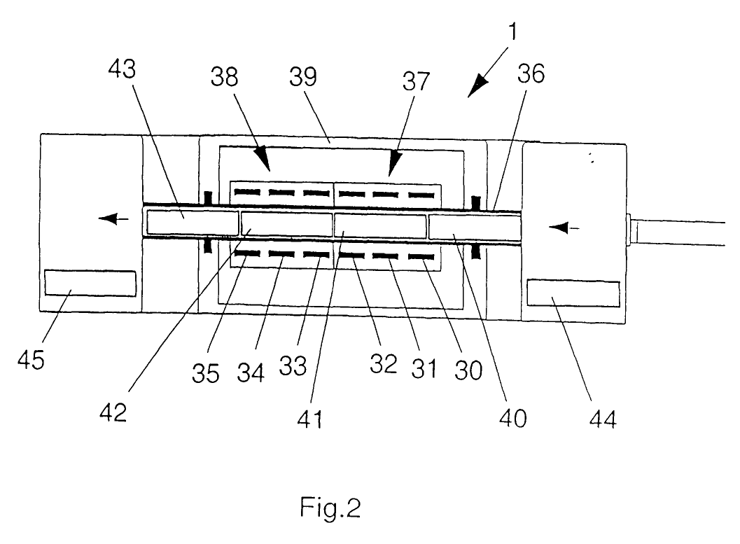

FIG. 2 shows a cut through the upper part of a furnace as shown in FIG. 1.

In accordance with one embodiment of the present invention Titan diboride powders can be produced by carbothermic reduction of a mixture of TiO₂ (Titanium-dioxide) and B₂O₃ (Boron-trioxide) following the reaction:

TiO₂(s)+B₂O₃(l)+5C(s)=TiB₂(s)+5CO(g),

that as such is similar to the process described in the above mentioned US-reference.

Production of high purity TiB₂ is rendered complicated by the effect of side-reactions being present when heating the reactants to the balancing temperature of the reaction, which implies heating to a temperature of 1450° C. and higher.

One basis of the present invention is the observation of the fact that C and B₂O₃ reacts at a temperature that can be as low as 1200° C. and form CO and BO gases in accordance with the following reaction:

C(s)+B₂O₃(l)=CO(g)+2BO(g)

When this reaction takes place, it has been found that the mixture will suffer from losses of C and B₂O₃ thus rendering a surplus of TiO₂. Further, a loss will be caused by the reaction between TiO₂ and C to form TiO(g) and CO(g). This reaction takes place at a temperature approximately 60° C. higher than the balance temperature for the reaction forrrming TiB₂.

In another embodiment of the present invention Titan-carbide powders can be produced by carbotherimc reduction of TiO1 (Titanium-dioxide) following the reaction:

TiO₂(s)+3C(s)=TiC(s)+2CO(g),

that as such is similar to the process described in the above mentioned US-reference.

In a third embodiment of the present invention titan-nitride powders can be produced by carbothermic reduction of a mixture of TiO₂ (Titanium-dioxide) in a nitrogen containing atmosphere following the reaction:

2TiO₂(s)+4C(s)+N₂(g)=2TiN(s)+4CO(g),

that as such is similar to the process described in the above mentioned US-reference.

The furnace in accordance with the present invention operates at atmospheric pressures. The heating of the mixture according to this embodiment is proceeded very rapidly in the range 1100° C. up to 1450° C., whereby the mentioned side-reaction will not be allowed to take place. In practice this is done by adapting the furnace to comprise two zones of temperature, one at approximately 1100° C. and the other at approximately 1450° C. As the mixture is thoroughly heated at 1100° C., the mixture is then moved to the other reaction zone which has a temperature of 1450° C. As a result of the rapid and controlled heating of the mixture in the second reaction zone, there will be a marginal loss of reactants. The heating of the mixture from 1100° C. to 1450° C. can in accordance with the invention be performed within a period as short as one minute. This is very rapid compared to the prior art solution which will represent more than 7 minutes heating time at the heating rate of 50° C./min. for the similar heating of the mixture.

In FIG. 1 there is shown a furnace 1 with a support base 2 housing all transformers and thyristor stacks for control of power to furnace heating elements. Further, the base includes a container receiving chamber rotation motor 6 comprising a transmission axle 3 and drive elements 4, 5. The drive elements may be transmission chains, drive belts or the like that co-operates with meshing elements on the furnace chamber axles 7, 8. The support base may further comprise control circuits for possible cooling systems and gas control circuits if inert gas supply means are installed. Functions such as programming of temperature, data logging, furnace chamber rotation speed control and safety circuits may be controlled by a programmable processing unit (not shown). These provisions are not further described here as this is as such common knowledge for those skilled in the art.

The furnace is provided with an entry section 9 which may comprise two compartments. One first, outer compartment can be accessed via a closure element such as a hinged door, for loading of the reaction container onto a transport carriage (not shown). In one embodiment, facilities can be available for purging the container and the outer compartment with an inert gas such as Argon before the container is transferred to a second inner compartment via a pneumatically operated, hermetically sealed inner door (not shown). At one end of the entry section there is arranged a pushing device, such as a pneumatically operated cylinder for pushing the container into the elongate reaction chamber 36 (see FIG. 2) of the furnace. If desired the O₂ partial pressure can be monitored by a sensor positioned in the outer compartment (not shown). Process gas such as Argon and CO can be collected via a collector device (not shown) connected to the inner compartment.

At the entry section there may be arranged at cooling transition assembly (not shown). This assembly may consist of a sealed inner and outer sleeve for instance made out of stainless steel. A cooling medium can be circulated between the two sleeves for instance via a spiral groove arranged between these sleeves (not shown). The assembly can be supported by means of bearings (not shown) mounted in the each furnace end plates 11, 12.

The heating zones 37, 38 comprise an insulated housing 39 together with heating elements 30, 31, 32, 33, 34, 35. The heating elements may completely surround the reaction chamber, and in the figure there is only the lower cross-section that of these elements that are numbered. The heater elements may for instance be of a graphite type. In the heating zones there may be arranged thermocouples to read the actual temperature and power leadthroughs for powering the heating elements. Said provisions may be connected with the processing unit. In this embodiment there are two main hot zones 37 and 38 that corresponds to the temperatures of 1100° C. and 1600° C. respectively. In this embodiment each main hot zone is subdivided into three minor hot zones with individual thermocouples, temperature controllers and heating elements for each hot zone. This configuration gives the ability to create an extremely uniform temperature along the entire length of each main zone (ca. +2° C.). The chamber may be continuously purged with Argon or other inert gasses to protect the graphite heater elements. It should be understood that the containers can be moved very rapidly from one zone to another by the pushing device.

The reaction chamber 36 can be built up by several parts (not shown) that are machined from high purity, high-density graphite. The parts may constitute two flanged end tubes which locate in the entry and unloading sections, two flange rings for the drive connection and three tubular sections which fit together using sliding joints. Any compensation for thermal expansion is then allowed for within the sliding joints. The complete assembly may be secured by the use of graphite composite screws and nuts. As shown in the figure the containers may be pushed through the reaction chambers in a chain like manner where one container abuts the adjacent one. In the first chamber of the entry section there is shown one container 44 ready to be loaded into the second chamber. Further in the reaction chamber there is arranged four containers 40, 41, 42, and 43 where the containers 41 and 42 are processed at different temperatures in section 37 and 38. The container 40 is about to enter the first heating zone 37, while the container 43 is about to leave the heating zone 38. One container 45 has been downloaded into the unloading section 13.

At the unloading section 13 there may be arranged a cooling transition assembly (not shown) This may be identical to the entry section assembly except for the length, which is increased to accommodate a complete container to facilitate rapid cool down following the container is removal of the container out of the 1600° C. hot zone.

The unloading is further quite similar to the entry section but there is no pushing device, but an extraction device to ensure the container is properly positioned before transfer to an outer compartment. Inert gas such as argon may be applied to purge the container in the unloading section.

The reaction containers or container tubes 40-45 can be made from medium grade graphite. Each container is assembled using an outer powder containment cylinder, inner gas flow tube, baffle plates and graphite felt filter discs (not shown). Thermal expansion of the powder charge is compensated for within the end filter assemblies.

In operation there are six major zones in the furnace in this embodiment:

1. Loading purging zone

2. Transition zone

3. 1100° C. pre-heat zone

4. 1600° C. reaction zone

5. Rapid cooling transition zone

6. Unloading zone

The furnace operates in a batch/continuous mode where containers are pushed consecutively through the furnace, as one container is inserted the last container in the cycle is removed. The residence time of a container in any zone is dependent on the reaction rate/time of the container in the reaction zone. Argon gas, or other inert gasses, continuously sweeps the container tube and containers to remove CO.

The container tube is rotated continuously. This impedes possible clumping and sintering, is an aid to continued mixing during the process and creates a very uniform temperature gradient within the container tube.

In a single batch cycle the process may be run as follows:

Raw material is prepared by weighting the component powders (Me-oxide, Carbon, and if necessary Boric acid) out in stochiometric amounts. The powders are then combined and mixed thoroughly in a ‘Y’ Blender or another appropriate type of mixer to form a batch (ca 10-12 kg). After mixing the material is pelletized. Size of pellet is typically 5 mm dia. −5 mm long. Following the pelletizing operation the batch is dried to remove any excess water from the mixture.

The material is processed by placing the batch of pelletized material into a clean reaction container. The filled container is then placed in the outer compartment of the load interlock of the entry section and purged with inert gas until 0.5% Oxygen is measured by the O₂ sensor. On completion of the purge cycle the container is transferred to the inner compartment where it is pushed into the load end transition zone by the pushing device. The container is then moved into the 1100° C. zone where final drying and removal of any trace amounts of water are removed and pre-heating of the charge takes place. Little or no reaction or losses occur at this temperature. When ready, the container is moved forward into the 1600° C. zone where reaction takes place. Heat up from 1100° C. to above 1450° C. is performed extremely rapid. During the process, reactant gas (CO) is swept through the preceding containers and out of the loading interlock, via the gas collecting device, and burnt off as CO₂. Residence time in the furnace at this temperature is about 1 hour. On completion of the reaction the container is moved into the rapid cooling transition zone. Rate of cooling approx. 500° C./min.

### EXAMPLE 1

Stochiometric mixtures of Titanium oxide, Carbon and Boric Acid were prepared according to the procedure presented above. Several experiments with different reaction temperatures in the reaction zone of the furnace have been performed. The reaction in the hot zone of the furnace takes place according to the chemical reaction:

TiO₂(s)+B₂O₃(l)+5C(s)=TiB₂(s)+5CO(g)

Reaction times for each experiment were recorded, and after completed reaction and cooling the reaction product was analyzed. Both product purity and particle size were measured and is reported in Table 1.

TABLE 1
Production of Titanium diboride according to the present invention.

| | Reaction | | | |
|---|---|---|---|---|
| Raw materials | temperature | Reaction time | Particle size | Purity |
| TiO₂:B₂O₃:C (kg) | [° C.] | [min] | [d₅₀/μm] | [%] |
| 1.000:0.872:0.752 | 1475 | 180 | 7 | >90 |
| | 1525 | 130 | 5 | >92 |
| | 1550 | 125 | 5 | >92 |
| | 1600 | 85 | 5 | >92 |

### EXAMPLE 2

Stochiometric mixtures or Zirconium oxide. Carbon and Boric Acid were prepared according to the procedure presented above. Again, more than one experiment was performed, wherein the reaction temperatures in the reaction zone of the furnace was varied in the different experiments. The reaction in the hot zone of the furnace takes place according to the chemical reaction:

ZrO₂(s)+B₂O₃(l)+5C(s)=5CO(g)

Reaction times for each experiment were recorded, and the reaction product was analyzed after completed reaction and cooling. Both product purity and particle size were measured and is reported in Table 2.

TABLE 2
Production of Zirconium diboride according to the present invention.

| | Reaction | | | |
|---|---|---|---|---|
| Raw materials | temperature | Reaction time | Particle size | Purity |
| ZrO₂:B₂O₃:C (kg) | [° C.] | [min] | [d₅₀/μm] | [%] |
| 1.000:0.565:0.487 | 1560 | 180 | 3 | >92 |
| | 1600 | 100 | 2 | >90 |
| | 1650 | 50 | 2 | >90 |

### EXAMPLE 3

A mixed boride powder was produced directly from stochiometric mixtures of Titanium oxide, Zirconium oxide, Carbon and Boric Acid, and from a mixture of pre-synthezised Titanium Zirconium oxide, Carbon and Boric Acid. The raw material powders were prepared according to the procedure presented above. Different reaction temperatures in the reaction zone of the furnace. The reaction in the hot zone can for all practical purposes be expressed through the equation:

TiO₂(s)+ZrO₂(s)+2B₂O₃(l)+10C(s)=2(Ti_{0.5}Zr_{0.5})B₂(s)+10CO(g)

Reaction times for each experiment were recorded, and after completed reaction and cooling the reaction product was analyzed. Both product purity and particle size were measured and is reported in Table 3.

TABLE 3
Production of Titanium-Zirconium mixed diboride according to the
present invention.

| | Reaction | Reaction | Particle | |
|---|---|---|---|---|
| Raw materials | temperature | time | size | Purity |
| TiO₂:ZrO₂:B₂O₃:C (kg) | [° C.] | [min] | [d₅₀/μm] | [%] |
| 1.000:1.542:1.743:1.504 | 1500 | 120 | 10 | >90 |
| 1.000¹:X¹:0.686:0.591 | 1550 | 120 | 10 | >90 |

¹ZrTiO₄

### EXAMPLE 4

Stochiometric mixtures of Titanium oxide and Carbon were prepared according to the procedure presented above. A single experiment was performed in which the temperature of the hot zone in the furnace was kept constant at predetermined temperature. The production of Titan-carbide powders in the present invention is be produced carbothermically according to the following the reaction:

TiO₂(s)+3C(s)=TiC(s)+2CO(g),

Again, after completed reaction and cooling, the reaction product was analyzed. The product purity and particle size are shown in Table 4.

TABLE 4
Production of Titanium carbide according to the present invention.

| | Reaction | | | |
|---|---|---|---|---|
| Raw materials | temperature | Reaction time | Particle size | Purity |
| TiO₂:C (kg) | [° C.] | [min] | [d₅₀/μm] | [%] |
| 1.000:0.451 | 1500 | 120 | 0.5 | >95 |

### EXAMPLE 5

Stochiometric mixtures of Titanium oxide and Carbon were prepared according to the earlier presented procedure. A single experiment was performed in which the temperature of the hot zone in the furnace was kept constant at predetermined temperature. Nitrogen gas was purged through the furnace during the experiment, and the production of Titanium nitride powder occurs according to the following the reaction:

2TiO₂(s)+4C(s)+N₂(g)=2TiN(s)+4CO(g),

After completed reaction and cooling, the reaction product was analyzed. The product purity and particle size are shown in Table 5.

TABLE 5
Production of Titanium nitride according to the present invention.

| | Reaction | | | |
|---|---|---|---|---|
| Raw materials¹ | temperature | Reaction Time | Particle size | Purity |
| TiO₂:C (kg) | [° C.] | [min] | [d₅₀/μm] | [%] |
| 1.000:0.301 | 1500 | 60 | 0.7 | >95 |

¹N₂ atmosphere

It should be understood that the present invention may be applied for the performance of other thermal reactions between two or more reactants than that given in the example. In principle the method and the furnace may be suitable for performing any thermal reaction where there is desired to pass very rapidly through temperature intervals where undesired side-reactions take place.

For instance, the method may be applied in the production of zirconium di-boride or Titanium carbide as shown in the examples. In this case the titanium oxide may simply be substituted by zirconium oxide, whereby the process is carried out in a manner similar to that described for titanium in the example. The method will be quite similar to that given for production of titanium diboride as these metals undergo quite similar reactions with the reactants.

1. A method for performing thermal reactions between at least two reactants that are mixed and arranged in a reaction chamber or container (40) that can be heated by means of a furnace (1), the furnace having provisions to rotate the reaction chamber about an axis of rotation,
characterised in that
the mixture is heated rapidly at certain transient temperature(s) or temperature range(s) between a first temperature and a second, higher temperature to minimize unwanted side-reactions by the reactants at said temperature(s) or temperature range(s) by moving the container from one temperature zone (37) in the furnace to one another (38).

2. A method in accordance with claim 1,
characterised in that
the container (40) is moved in the same direction as its axis of rotation.

3. A method in accordance with claim 1, for the production of refractory Hard Metal powders, i.e. metal-diboride powders comprising mixing reactants of a metal oxide, carbon and boron trioxide to form a homogenous mixture, heating said mixture to above 1450° C. in an inert atmosphere to perform a reaction between said reactants,
characterised in that
the mixture is heated evenly to a temperature of approximately 1100° C., followed by very rapidly further heating to approximately 1450° C., to reduce loss of reactants by the formation of CO and BO gases in this heating range.

4. A method in accordance with claim 3,
characterised in that
the metal oxide is Titanium oxide.

5. A method in accordance with claim 3,
characterised in that
the metal oxide is Zirconium oxide.

6. A method in accordance with claim 3,
characterised in that
the metal oxide is selected from the group Hafnium oxide, Lanthanum oxide, Tantalum oxide and Magnesium oxide.

7. A method in accordance with claim 1, for the production of refractory Hard Metal powders, i.e. metal-carbide powders comprising mixing reactants of a metal oxide and carbon to form a homogenous mixture, heating said mixture to above 1450° C. in an inert atmosphere to perform a reaction between said reactants,
characterised in that
the mixture is heated evenly to a temperature of approximately 1100° C., followed by very rapidly further heating to approximately 1450° C., to reduce loss of reactants by the formation of CO gas in this heating range.

8. A method in accordance with claim 7,
characterised in that
the metal oxide is Titanium oxide.

9. A method in accordance with claim 7,
characterised in that
the metal oxide is selected from the group Boron oxide, Tungsten oxide, Zirco-nium oxide, Hafnium oxide, Lanthanum oxide, Tantalum oxide and Silicon oxide.

10. A method in accordance with claim 1, for the production of refractory Hard Metal powders, i.e. metal-nitride powders comprising mixing reactants of a metal oxide and carbon to form a homogenous mixture, heating said mixture to above 1450° C. in a nitrogen containing atmosphere to perform a reaction between said reactants,
characterised in that
the mixture is heated evenly to a temperature of approximately 1100° C., followed by very rapidly further heating to approximately 1450° C., to reduce loss of reactants by the formation of CO gas in this heating range.

11. A method in accordance with claim 10,
characterised in that
the metal oxide is selected from the group Silicon oxide, Titanium oxide, Aluininium oxide, Boron oxide, Gallium oxide and Tantalum oxide.

12. A furnace (1) for performing thermal reactions between at least two reactants that are mixed and arranged in a reaction chamber or container (40) that can be placed in the furnace, the furnace further comprises heating means and provisions to rotate the container about an axis of rotation,
characterised in that
the furnace comprises a rotary elongate chamber (36) with an entry- (9) and an outlet section (13) for the container (40), whereby heating means (30-35) are arranged along the elongate chamber (36) to provide at least two different heating zones (37, 38) along the length of the elongate chamber.

13. A furnace in accordance with claim 12,
characterised in that
the heating zones (37, 38) are aligned one after the other, whereby the container (40) can be moved axially with respect to the elongate chamber trough each heating zone.

14. A furnace in accordance with claim 13,
characterised in that
the container (40) is moved through the elongate chamber (36) by means of a pushing device (10).

15. A furnace in accordance with claim 12,
characterised in that
it is provided with automatic or semi-automatic handling equipment that for entering the container (40) into the furnace (1) and for removing the container from the same.

16. A furnace in accordance with claim 12,
characterised in that
it is provided with inert gas supply means to purge ambient air out of the zones where the reaction(s) takes place.

17. A furnace in accordance with claim 12,
characterised in that
the furnace (1) have provisions such as collecting devices or hoods at its entry-and/or outlet section (9, 13) for collecting process gas(es) from the furnace.

18. A furnace in accordance with claim 12-17,
characterised in that
the operation of the furnace is controlled in accordance with a programmable processing unit.
